(19) United States
(12) Patent Application Publication
(10) Pub. No.: US 2006/0209849 A1
(43) Pub. Date: Sep. 21, 2006

(54) Method for and apparatus for aggregating incoming packets into optical for an optical burst switched network

(76) Inventor: Miguel De Vega Rodrigo, Woluwe St. Lambert Brussells (BE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/568,237

(22) PCT Filed: Aug. 6, 2004
(86) PCT No.: PCT/EP04/51732

§ 371 Date: Feb. 14, 2006

(30) Foreign Application Priority Data
Aug. 14, 2003 (EP) 03018496.4

(51) Int. Cl. H04L 12/56; H04J 3/16; H04J 3/04; H04L 12/28

(52) U.S. Cl. 370/401; 370/535; 370/412; 370/466

(57) ABSTRACT

Incoming packets are aggregated into optical bursts in an edge node of an Optical Burst Switched Network by the following. Storing the incoming packets to generate an optical burst. Associating each incoming packets with a generated random binary digit with a probability for a first and a second value of the binary digit. A packet with a binary digit having the first value indicates a transition between optical bursts. Sending the optical burst with the aggregated packets when a transition is indicated by the first value.

### CROSS REFERENCE TO RELATED APPLICATIONS

This application is the US National Stage of International Application No. PCT/EP2004/051732, filed Aug. 6, 2004 and claims the benefit thereof. The International Application claims the benefits of European application No. 03018496.4 EP filed Aug. 14, 2003, both of the applications are incorporated by reference herein in their entirety.

### FIELD OF INVENTION

The present invention relates to a method for aggregating incoming packets into optical bursts and an edge not apparatus for an optical burst switched network.

### BACKGROUND OF INVENTION

In Optical Burst-Switched networks, or so called OBS networks, packets, e.g. Internet Protocol (IP) packets, Asynchrony Transfer Mode (ATM) cells or protocol data units (PDUs), are aggregated into optical bursts in order to be transferred through the OBS network or respective optical network. The conversion of packets into optical bursts takes place in the edge nodes of an OBS network according to a certain aggregation strategy. The solutions so far provide two main aggregation strategies: the aggregation strategy with timeouts and the aggregation strategy with a buffer limit.

First we will discuss the aggregation strategy with timeouts. A schematic example is shown in FIG. 1. In this scheme, packets 102 are added or padded to the burst 104 which is being generated in a buffer 106 until a certain timer T expires. Then the burst 108 is sent.

The second, Aggregation strategy with buffer limit will be discussed with reference to FIG. 2. In this scheme, packets 202 are added or padded to the burst 204 which is being generated in a buffer 206 until the buffer is full. Then the burst 208 is sent.

Once the packets are transformed into bursts and sent into the OBS network, they travel in the OBS network through a series of optical switches to a certain destination. At best, these optical switches have limited storage capabilities, e.g. fiber delay lines, and at worst, no storage capabilities at all in the normal case. Therefore, collisions among optical bursts occur. Major performance parameters of an OBS network are thus the burst blocking probability, the throughput and the delay.

### SUMMARY OF INVENTION

The two main aggregation strategies timeout and buffer limit have the disadvantage of a certain blocking probability and maximum achievable throughput.

It is an object of the invention to reduce the blocking probability and increase the throughput of an OBS network.

This object is achieved by the features recited in the independent claims.

The novel inventive aggregation strategy is based on the following widely accepted assumption for highly multiplexed traffic (core networks): the packet arrival rate process is determined according to a Poisson distribution. With this assumption, the idea is to consider the random selection property of any Poisson process, in order to obtain a Poisson process of a lower arrival rate.

This lower-rate Poisson process will mark the beginning of a new optical burst or the end of an optical burst. So it is possible to assure that the burst send and arrival process is Poisson. In addition, the inter-arrival times between bursts will be negative-exponential distributed, as the inter-arrival times of any Poisson process.

It shall be appreciated that advantages of the invention are:
A lower blocking probability in the optical switches is provided, as compared to the standard aggregation strategies.
Predictability of the blocking probability. The blocking probability can be calculated with the Erlang-B formula. Whereas for the other aggregation strategies no analytical formula is known.
Due to the lower blocking probability a higher throughput in optical switches of the OBS network is achieved.
Predictability of the throughput. The throughput, unlike with the prior art strategies, can be calculated with the help of the Erlang B formula.
It is easier to calculate waiting times for bursts and/or headers of bursts.
A lower waiting time for the optical headers in the optical switches.
In the case burst buffering is available, e.g. by the use of fiber delay lines, a lower waiting time for bursts in the optical switch is achieved.

Further developments of the invention are identified in the dependent claims.

### BRIEF DESCRIPTION OF THE DRAWINGS

An exemplary embodiment of the invention is described in greater detail below with reference to a drawing.

Shown in the drawing are:

FIG. 1 the initially cited prior art.

FIG. 2 the initially cited prior art.

FIG. 3 an schematically example for the aggregation and random selection process.

FIG. 4 a graph with the blocking probability as a function of the load for different aggregation strategies.

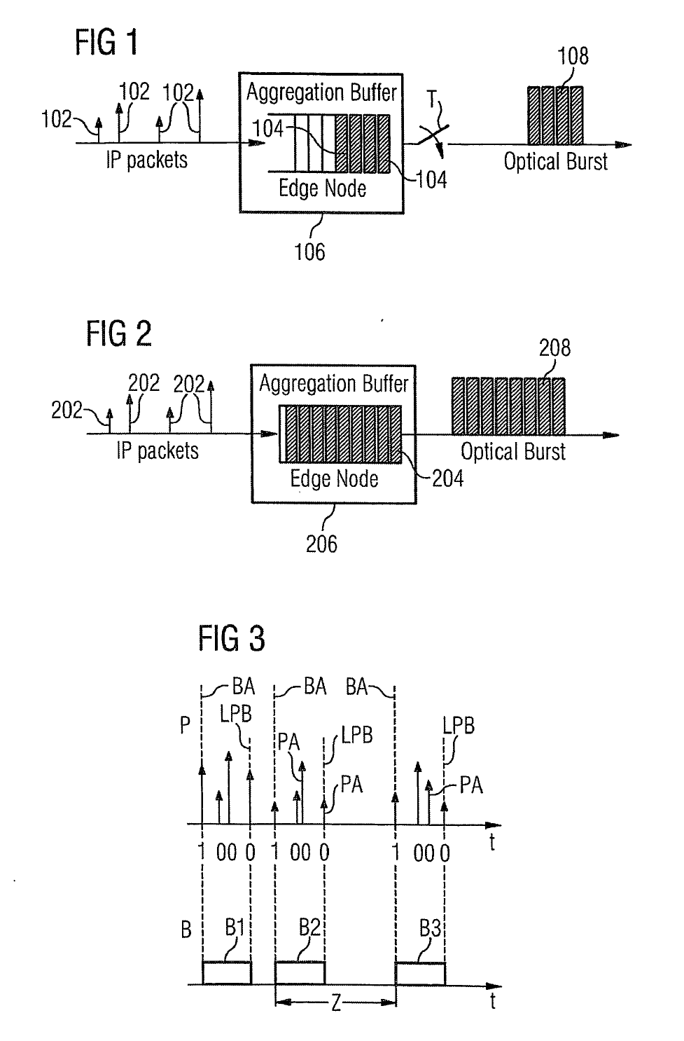

### DETAILED DESCRIPTION OF INVENTION

FIG. 3 shows two associated timelines P and B. On the first timeline P packets PA, pictured as arrow line, are received in chronological order, e.g. IP packets, ATM cells or PDUs. Every packet is associated with a generated random binary digit. A binary digit has a first and a second value, e.g. 1 for the first value and 0 for the second value or opposite. So, every packet is associated either with a 1 or a 0. The random binary digits can be generated by a Bernoulli random generator, according to a Bernoulli probability distribution. The probability for every value of the random binary digit, thus the probability (p) for the 1's and (1−p) for the 0's, is determined by a certain probability distribution, e.g. p(1)=0.01 and p(0)=0.99. These packets are aggregated in a buffer to accumulate an optical burst. A packet with an associated first value, e.g. with a 1 indicates a transition between optical bursts, e.g. the beginning of a new burst. In FIG. 3 this is labeled with BA. The chronological last packet with a 0 before a packet with a 1, is the last packet of the burst, marked with LPB in FIG. 3. On the second timeline B in FIG. 3 the resulting Bursts B1, B2 and B3 are shown. The time difference Z between the beginning of two successive bursts is called inter-arrival time. The aggregation delay is the delay experienced by a packet in the edge node until the burst to which it belongs is completed. After appearance of a packet with a 1, a new burst begins and the old burst is send into the OBS network.

The used probability distribution determines the average number of packets per burst. E.g. the average number of packets per burst is equal to 1/p(1). For the example, if p(1)=0.01, the average number of packets per burst is 1/p(1)=100 packets per burst.

The method can also be realized, that the second value indicates a transition between optical bursts.

Also the first value indicates, instead of the beginning of a new burst, the end of the aggregated packets and by that the end of the aggregated burst. The main idea is, that a generated random digit with a certain probability indicates the beginning or the end of a burst, which consists of aggregated packets, e.g. IP packets.

The invention can be implemented by the following steps/algorithm:
Every time the edge node receives a packet, e.g. an IP packet, it sends it to the buffer.
Then the edge node reads the generated associated random binary digit/random number corresponding to the next packet.
If the associated random binary digit/random number for the next packet is a first value, e.g. a 1, the accumulated burst in the buffer is sent.
Otherwise, do nothing.

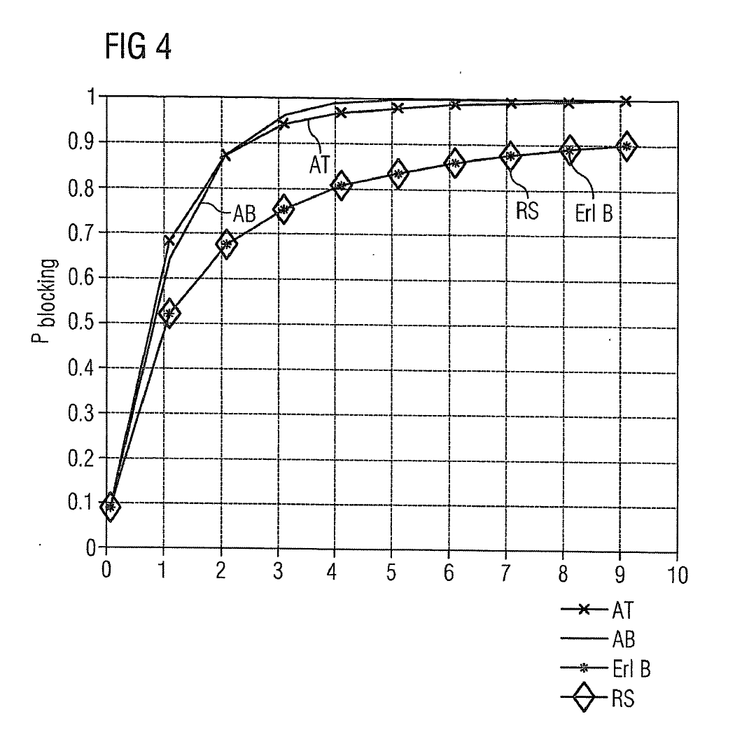

A simulation has been done with Matlab® in order to calculate the blocking probability in an optical switch with no wavelength conversion available as a function of the load. The results are presented in FIG. 4. In FIG. 4 AT means aggregation strategy with aggregation timer, AB means aggregation strategy with aggregation buffer, Erl B means theoretically possible load according to Erlang B formula and RS means inventive aggregation strategy with random selection.

It can be observed that the inventive random selection strategy leads to the lowest blocking probability and furthermore it matches the Erlang-B formula predictions.

1.-9. (canceled)

10. A method for aggregating incoming packets into optical bursts in an edge node of an Optical Burst Switch Network, comprising:
storing the incoming packets to generate an optical burst;
associating each incoming packet with a generated random binary digit with a probability for a first and a second value of the binary digit; and
sending the optical burst with the aggregated packets when a transition is indicated,
wherein the a binary digit having the first value indicates the transition between optical bursts,
whereby a lower blocking probability in the optical switches is provided, and
whereby the lower blocking probability can be calculated with an Erlang-B formula, thus providing predictability of the throughput.

11. The method according to claim 10, wherein the transition is a beginning of a new optical burst.

12. The method according to claim 10, wherein the transition is an end of the new optical burst.

13. The method according to claim 10, wherein the optical burst is sent through the Optical Burst Switched Network.

14. The method according to claim 10, wherein the random binary digit is generated according to a Bernoulli probability distribution.

15. The method according to claim 10, wherein IP packets are used as incoming packets.

16. A method for aggregating incoming packets into optical bursts in an edge node of an Optical Burst Switched Network,
storing the incoming packets to generate an optical burst;
generating a random binary digit with a probability for a first and a second value of the binary digit; and
sending the optical burst when the random binary digit is a first value,
whereby a lower blocking probability in the optical switches is provided, and
whereby the lower blocking probability can be calculated with an Erlang-B formula, thus providing predictability of the throughput.

17. The method according to claim 16, wherein the optical burst is sent through the Optical Burst Switched Network.

18. The method according to claim 10, wherein the random binary digit is generated according to a Bernoulli probability distribution.

19. The method according to claim 16, wherein IP packets are used as incoming packets.

20. An edge node apparatus for an Optical Burst Switched Network for aggregating incoming packets into optical bursts, comprising:
a buffer to accumulate the incoming packets as an optical burst; and
a random generator to generate a binary digit with a probability for a first and second value of the binary digit, such that each incoming packet is associated with a generated binary digit,
wherein the first value indicates a transition between optical bursts,
wherein the optical burst with the aggregated packets is send when a transition is indicated,
whereby a lower blocking probability in the optical switches is provided, and
whereby the lower blocking probability can be calculated with an Erlang-B formula, thus providing predictability of the throughput.

21. The apparatus according to claim 20, wherein binary digit is generated according to a Bernoulli probability distribution.
